(19) United States
(12) Patent Application Publication
(10) Pub. No.: US 2026/0223126 A1
(43) Pub. Date: Jul. 30, 2026

(54) METHODS AND APPARATUS FOR OPERATING ENHANCED REDUCED CAPABILITY DEVICES IN WIRELESS COMMUNICATION

(71) Applicant: APPLE INC., Cupertino, CA (US)

(72) Inventors: Hong He, San Jose, CA (US); Seyed Ali Akbar Fakoorian, San Diego, CA (US); Dawei Zhang, Saratoga, CA (US); Wei Zeng, San Diego, CA (US); Haitong Sun, Cupertino, CA (US); Ankit Bhamri, Bad Nauheim (DE); Chunhai Yao, Beijing (CN); Weidong Yang, San Diego, CA (US); Chunxuan Ye, San Diego, CA (US); Jie Cui, San Jose, CA (US)

(21) Appl. No.: 19/145,663

(22) PCT Filed: Jan. 23, 2024
(86) PCT No.: PCT/CN2024/073661

§ 371 Date: Jul. 3, 2025

Related U.S. Application Data
(60) Provisional application No. 63/482,941, filed on Feb. 2, 2023.

(51) Int. Cl. H04W 72/231; H04L 5/00; H04W 72/0453; H04W 72/51; H04W 76/20

(52) U.S. Cl. CPC H04W 72/231; H04L 5/0044; H04W 72/0453; H04W 72/51; H04W 76/20

(57) ABSTRACT

Embodiments herein provide a wireless communication system for enhanced reduced capability (eRedCap) user devices. The wireless communication system may include a network node that informs user equipment whether eRedCap devices are barred or not. A UE may indicate that it is an eRedCap device. The UE may be configured to transmit via an uplink Physical Uplink Shared Channel comprising contiguous resource blocks.

### TECHNICAL FIELD

This application relates generally to wireless communication systems, including support for enhanced reduced capability devices.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a signal flow diagram of a wireless communication system identifying Rel-18 eRedCap devices based on a PRACH transmission in accordance with some embodiments.

FIG. 2 illustrates a master information block in accordance with some embodiments.

FIG. 3 illustrates a scheduling DCI comprising an access restriction indication in accordance with some embodiments.

FIG. 4 illustrates an eRedCap barred IE in accordance with some embodiments.

FIG. 5 illustrates a Frequency Domain Resource Allocation (FDRA) for Rel-18 eRedcap UEs in accordance with some embodiments.

FIG. 6 illustrates an embodiment wherein both Type-0 and Type-1 RAs may be supported with the restriction of contiguous RBs.

FIG. 7 illustrates a method for a UE for frequency domain resource allocation in accordance with some embodiments.

FIG. 8 illustrates a method for a network node for frequency domain resource allocation in accordance with some embodiments.

FIG. 9 illustrates an initial uplink BWP for Rel-18 eRedCap and an initial uplink BWP for non-eRedCap in accordance with some embodiments.

FIG. 10 illustrates partially overlapped resource blocks of PUCCH resources where the devices use different base sequences in accordance with some embodiments.

FIG. 11 illustrates partially overlapped resource blocks of PUCCH resources where the devices use an orthogonal code to limit interference in accordance with some embodiments.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Wireless communication systems support UEs with a variety of different capabilities. Some UEs are built to robustly support many of the features of the wireless communication system. Conversely, some UEs may be designed for reduced complexity and/or lower power consumption. The wireless communication system may use different frameworks to support the different UEs.

Third Generation Partnership Project (3GPP) has established a framework for enabling reduced capability (RedCap) new radio (NR) devices. The devices supported through this framework may be referred to as reduced capability (RedCap) UEs. The RedCap UEs may be designed for a range of use cases, including industrial sensors, video surveillance, and wearables use cases. RedCap UEs may be have requirements for low UE complexity and sometimes also for low UE power consumption.

It may be desirable to further expand the market for RedCap use cases with relatively low cost, low energy consumption, and low data rate requirements. For instance, it may be desirable to expand the capability for industrial wireless sensor network use cases. These new devices may have enhanced capabilities and thus may be referred to as enhanced RedCap (eRedCap) UEs. As the eRedCap devices are to be implemented in 3GPP's Release 18, they may also be referred to as Rel-18 eRedCap UEs or devices. However, the expansion of the use of RedCap devices may introduce additional issues.

For instance, a first issue may be whether or not a separate early indication can be supported for eRedCap UE, and if the early indication is supported how the eRedCap indication should be implemented. Embodiments herein describe eRedCap indications that may be used by the network to identify that the device is an eRedCap device and not simply a RedCap device.

A second issue may be that due to different baseband (BB) bandwidth (BW) requirements between Rel-18 eRedCap UEs and other UEs (including both Rel-17 Redcap and legacy normal devices), support separate cell access control for Rel-18 eRedCap UE may be desirable. This may give the network flexibility to control whether to allow eRedCap UEs on a cell or not. Embodiments, herein describe ways in which to implement cell access control for eRedCap UEs.

A third issue is how to reduce UE complexity for eRedCap UEs. There may be an option to use bandwidth 3 (BW3) and peak data rate 3 (PR3) to reduce BB bandwidth for eRedCap UEs. In addition, the exact resource block (RB) number and detailed Frequency Domain Resource Allocation (FDRA) schemes remain undecided for eRedCap devices. Embodiments herein may use BW3, PR3, and provide a detailed RB number and FDRA schemes.

A fourth issue is to ensure coexistence of the eRedCap UEs with non-RedCap UEs and Rel-17 RedCap UEs. Embodiments herein provide methods to coordinate Physical Uplink Control Channel (PUCCH) orthogonality between eRedcap-PUCCH without frequency hopping (FH) and legacy PUCCH with FH.

There is a clear need to develop solutions for the open issues listed above to improve the resource efficiency for Rel-18 eRedcap and legacy UEs, including both Rel-17 Redcap and normal devices. Embodiments herein provide solutions for these issues.

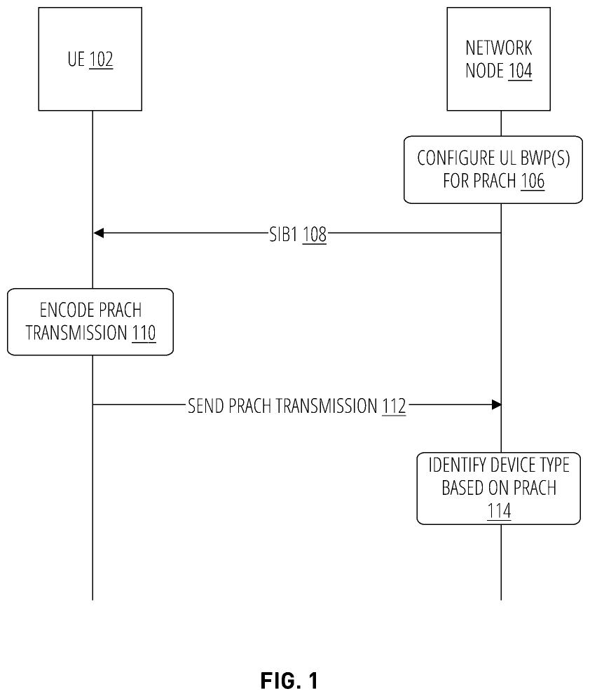

Early indication of Rel-18 eRedCap devices provides a few benefits, including allowing a larger transport block size (TBS) in message 3 (Msg3) for random access based small data transmission (RA-SDT) for Rel-17 Redcap UE, and in larger TBS for Msg4 (e.g., with Radio Resource Control (RRC) reconfiguration information) and Msg5 (if the UE comes from Idle) than what eRedCap can handle. According to certain aspects of this disclosure, a variety of approaches may be considered to support early indication of Rel-18 eRedCap UEs. For example, FIG. 1 illustrates a signal flow diagram of a wireless communication system identifying Rel-18 eRedCap devices based on a PRACH transmission.

In some embodiments, the network node 104 may determine the type of the UE 102 based on the initial uplink bandwidth part (BWP) used for a Physical Random Access Channel (PRACH) transmission. In these embodiments, the network node 104 can identify whether the UE 102 is a Rel-18 eRedCap device without the UE 102 explicitly providing that information. Instead, the device type may be communicated implicitly based on which uplink BWP the UE 102 uses for a PRACH transmission.

The network node 104 may configure 106 two uplink BWPs for PRACH. A first BWP may be used by Rel-17 Redcap UE and non-RedCap UEs. A second BWP may be used by Rel-18 eRedCap devices. The network node 104 may transmit configuration information for the two uplink BWPs via a SIB1 108. The UE 102 may encode 110 and transmit 112 a PRACH transmission on one of the two configured BWPs.

The network node 104 may receive the PRACH transmission and identify 114 the device type based on the BWP that the UE 102 used to send the PRACH. The network node 104 may identify the UE 102 as a Rel-18 eRedcap device type based on a PRACH transmission sent on a Rel-18 separate initial UL BWP.

In other embodiments, the network node 104 may identify the UE 102 as a Rel-18 eRedCap devices based on Msg1 transmission, including dedicated RACH occasions (ROs) or dedicated PRACH preamble configured by SIB1 108 within a shared initial uplink BWP or an initial uplink BWP that is partially overlapped with Rel-17 initial UL BWP. For example, the network node 104 may configure 106 the initial uplink BWP and send the SIB1 108 to the UE 102. The SIB1 108 may configure dedicated ROs or PRACH preamble for Msg1 transmission. In some embodiments, the Msg1-based early identification is explicitly enabled by a dedicated IE in SIB1 108 message for Rel-18 eRedcap UEs. In some embodiments, the Msg1-based early identification is implicitly enabled or disabled by the presence of a dedicated RACH configuration by the network.

The UE 102 may encode 110 and send a Msg1 transmission using the dedicated RO or PRACH preamble to indicate that it is an eRedCap device. The network node 104 may identify 114 the UE as an eRedCap device if the Msg1 transmission uses the dedicated RO or PRACH preamble.

In other embodiments, two dedicated logical channel ID (LCIDs), one for Common Control Channel (CCCH) and other for CCCHI, may be used by Msg3 (in a 4-step RACH procedure) or MsgA PUSCH transmission (in a 2-step RACH procedure) to early identify Rel-18 eRedCap devices. In other words, the UE 102 may send the network node 104 an indication that it is a Rel-18 eRedCap device using the two dedicated LCIDs. In some embodiments, the Msg-3 early indication is always enabled and used by Rel-18 eRedcap. In some embodiments, a new information element (IE) may be introduced in SIB1 for the network to explicitly indicate the enabling or disabling of Msg3 early indication for Rel-18 eRedcap.

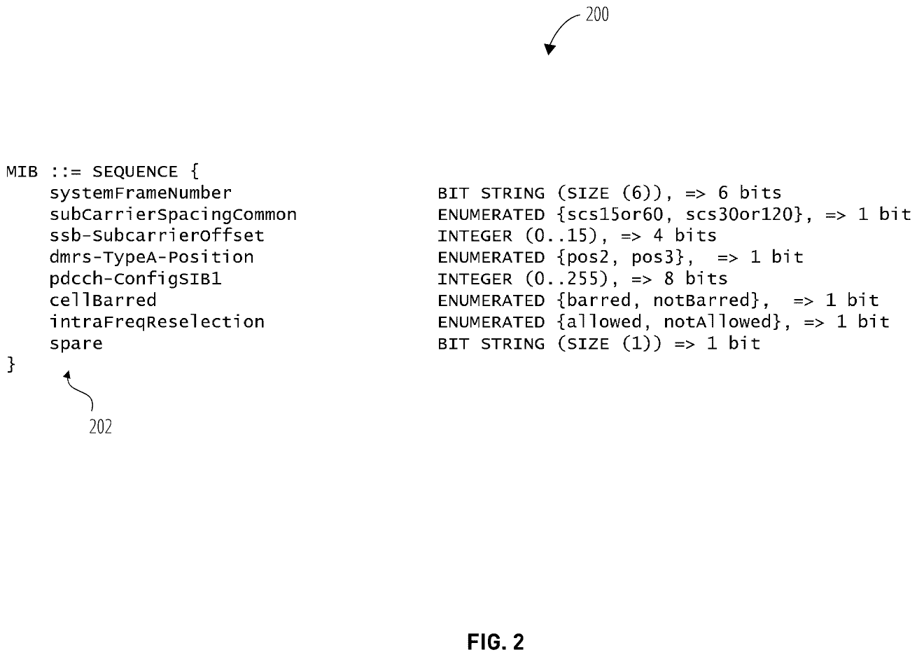

In accordance with the present disclosure, a variety of embodiments and techniques may be considered for access restriction indication for Rel-18 eRedcap devices by the network. A network node may indicate to a UE whether Rel-18 eRedCap UE are barred from a cell. If a Rel-18 eRedCap UE determines that it is barred, the UE may cease attempting to establish a connection with the cell. FIGS. 2-4 illustrate multiple ways in which the network node may convey the access restriction to the UE.

FIG. 2 illustrates a master information block (MIB 200) in accordance with some embodiments. In some embodiments, the network node may encode the MIB with an indication of whether the eRedCap devices are barred from a cell. For example, the spare bit 202 may be repurposed as an eRedcapCellBarred IE to indicate whether the cell is barred for Rel-18 eRedcap UE or not.

In some embodiments, Physical Broadcast Channel (PBCH) payload may be used for the access restriction indication for Rel-18 eRedcap devices by the network. For example, at least for FR1 licensed band, one of two reserved bits ‘a(6)’ and ‘a(7)’ in PBCH payload may be re-interpreted as an eRedcapCellBarred IE to indicate whether the cell is barred for Rel-18 eRedcap UE. The network node may set the eRedcapCellBarred IE in the PBCH payload to indicate whether the cell is barred.

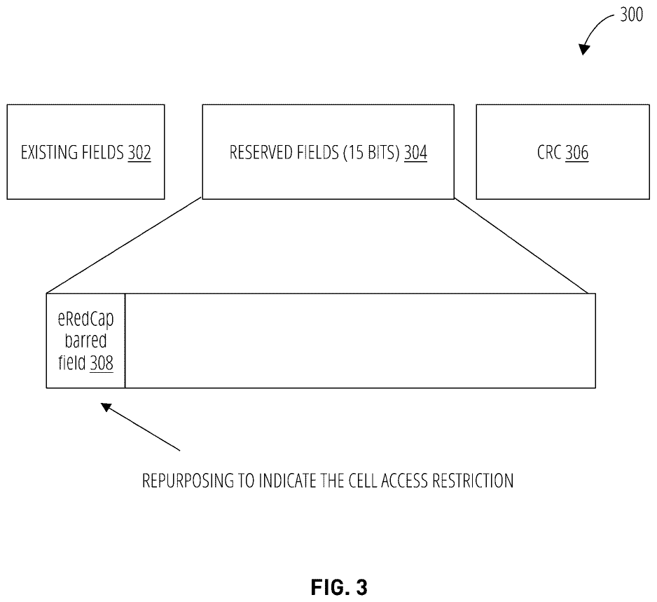

FIG. 3 illustrates a scheduling DCI (e.g., DCI Format 1_0 300) comprising an access restriction indication in accordance with some embodiments. The DCI Format 1_0 300 may consist of existing fields 302 for scheduling, reserved bits 304, and a cyclic redundancy check field (CRC 306). In NR, there may be 15 reserved bits 304 in DCI Format 1_0 with cyclic redundancy check (CRC) scrambled by System Information-Radio Network Temporary Identifier (SI-RNTI). The DCI Format 1_0 300 may be used to schedule SIB messages.

In some embodiments, one of the reserved bits 304 may be re-interpreted to indicate whether the cell is barred for Rel-18 eRedcap UEs. For example, one of the reserved bits 304 (e.g., the ‘sparse’ bit in MIB payload) may be assigned as an eRedCap barred field 308. A network node may set the eRedCap barred field 308 to indicate whether or not Rel-18 eRedcap UEs are barred from a cell. A Rel-18 eRedcap UE may receive and decode the DCI Format 1_0 300 to determine the barred status based on the eRedCap barred field 308.

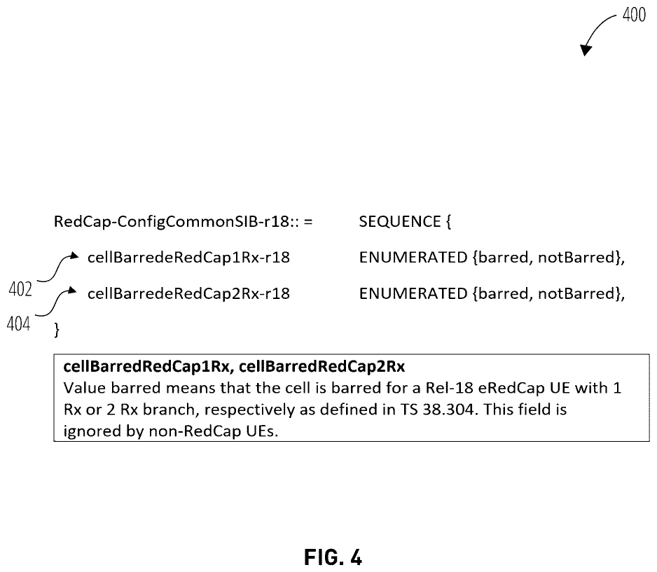

FIG. 4 illustrates a eRedCap barred IE 400 in accordance with some embodiments. In some embodiments, a new IE (e.g., eRedCap barred IE 400) may be introduced in SIB1 with {barred, notBarred} values to indicate the access restriction of the Rel-18 eRedcap devices. A network node may set the eRedCap barred IE 400 to barred if Rel-18 eRedcap UEs are barred from a cell, or set the eRedCap barred IE 400 to not barred if Rel-18 eRedcap UEs are allowed on the cell. The network node may send the eRedCap barred IE 400 to a UE via an SIB1.

The eRedCap barred IE 400 may include cellBarredRedCap1Rx-r18 variable 402 and a cellBarredRedCap2Rx-r18 variable 404. Value barred means that the cell is barred for Rel-18 eRedCap UE with 1 Rx or 2 Rx branch. The cellBarredRedCap1Rx-r18 variable 402 and a cellBarredRedCap2Rx-r18 variable 404 may be ignored by non-RedCap UEs.

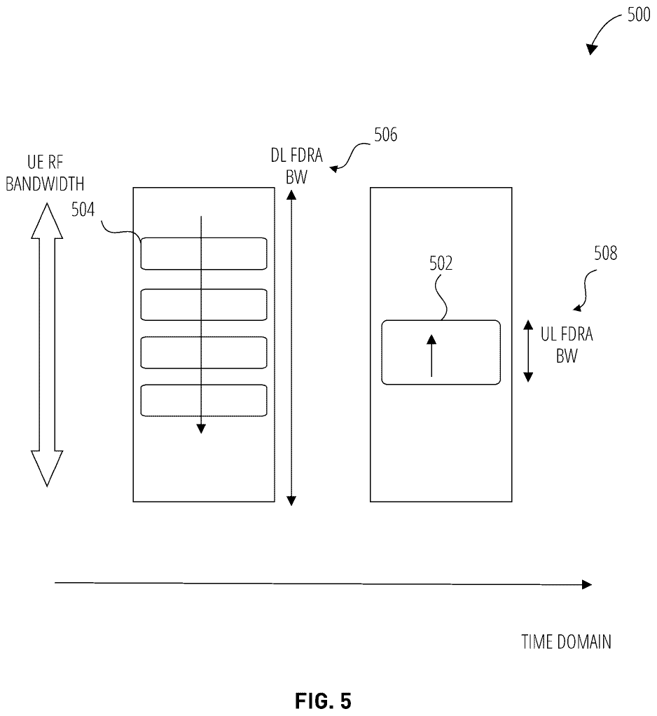

FIG. 5 illustrates a Frequency Domain Resource Allocation (FDRA 500) for Rel-18 eRedcap UEs in accordance with some embodiments. Some embodiments herein may use FDRA to reduce bandwidth of Rel-18 eRedcap UEs. As illustrated, FDRA 500 may be different for uplink and downlink. In some embodiments, the uplink and downlink for Rel-18 eRedcap UEs may have the same maximum resource block (RB) numbers, however the arrangement of RBs may be different. In some embodiments, the downlink RBs 504 may be discontinuous and the uplink RBs 502 may be continuous and both may have the same maximum RB numbers for Rel-18 eRedCap UEs.

In some embodiments, FDRA for uplink Physical Uplink Shared Channel (PUSCH) may appear as shown in the uplink FDRA bandwidth 508. In some embodiments for Rel-18 eRedcap, only contiguous uplink RBs 502 within an active bandwidth part of size of

$${N}_{U L , B W P}^{s i z e}$$

is supported for uplink RB allocation.

Various alternatives may be considered to determine a possible max number of RBs that the UE may transmit:

$${N}_{R B}^{U L} .$$

For instance in some embodiments, the maximum transmission bandwidth configuration N_{RB} corresponding to 5 MHz as the values of

$${N}_{R B}^{U L}$$

may be reused. For example,

$${N}_{R B}^{UL} = 25 RBs$$

(15 kHz subcarrier spacing (SCS)) and

$${N}_{R B}^{U L} = 11 RBs$$

(30 kHz SCS). NEW implementations for Rel-18 eRedcap UE when a component carrier (CC) is operated with 5 MHz BW may be avoided within this embodiment.

In some embodiments, a relaxation variable may be introduced to simplify implementation. For example, within one possible embodiment, new values based on the current N_{RB} value defined for 5 MHz CC may be defined as:

$${N}_{R B}^{U L} = {N}_{R B} + Δ . Δ \geq 0 ,$$

where exact values are determined to ensure the

$${N}_{U L , B W P}^{max , size} = {2}^{x} {3}^{y} {5}^{z}$$

to simplify UE implementation for Fast Fourier Transform (FFT) operation and therefore may be SCS-specific. Following this rule, Δ=0, 1 for 15 kHz SCS and 30 kHz SCS, respectively.

In some embodiments, FDRA for downlink unicast Physical Downlink Shared Channel (PDSCH) may be as shown in downlink FDRA bandwidth 506. In some embodiments, both contiguous (Type-1 RA) and non-contiguous RBs 504 (Type-0 RA) spanning over an active bandwidth of size

$${N}_{D L , B W P}^{s i z e}$$

may be supported. Herein, the maximum value of the active uplink bandwidth part (i.e.,

$${N}_{UL , BWP}^{s i z e} )$$

is denoted as

$${N}_{U L , B W P}^{max , size} .$$

Similarly, the maximum value of the active downlink bandwidth part (i.e.,

$${N}_{D L , B W P}^{s i z e} ) .$$

In some embodiments, different maximum bandwidth size may be are supported for Rel-18 eRedcap device in downlink and uplink including both frequency division duplex (FDD) and time division duplex (TDD) system. For example, in some embodiments

$${N}_{D L , B W P}^{s i z e} > {N}_{U L , B W P}^{max , size} .$$

In some embodiments,

$${N}_{R B}^{U L} = {N}_{R B}^{DL}$$

to ensure a same data processing requirement in downlink and uplink.

Embodiments herein may use a variety of FDRA solutions to allocate contiguous RBs (e.g., contiguous uplink RBs 502) for PUSCH transmission. In some embodiments, only uplink RA Type 1 (i.e., SLIV-based) may be is supported for PUSCH resource allocation for Rel-18 eRedcap UEs. For RA Type 1 RA, the resource indication value (RIV) field in DCI may correspond to a length in terms of contiguously allocated RBs. For example, the length of the RBs (L_{RBs}) may be less than or equal to the minimum of the number of RBs and the value of the active uplink bandwidth part. In other words,

$${L}_{R B s} \leq min ( {N}_{R B}^{U L} , {N}_{U L , B W P}^{s i z e} )$$

within an active bandwidth part of size

$${N}_{U L , BWP}^{s i z e} ,$$

where

$${N}_{R B}^{U L}$$

is the maximum number of RBs supported by Rel-18 eRedcap device.

In some embodiments, a wireless communication system may support both Type-0 and Type-1 RAs with the restriction of contiguous RB. In other words, in these embodiments both Type-0 and Type-1 RAs for contiguous RBs. For RA Type-0 RA, the following sub-fields may be introduced for Rel-18 Redcap UEs to reduce DCI overhead. A Sub-Field 1 may indicate the starting RBG index denoting as RBGₛₜₐᵣₜRBG start. Thus, the Sub-Field 1 may comprise a RGB index indicator. A Sub-Field 2 may indicate a length field with

$${N}_{R B G} = [ {log}_{2} ( min ( {N}_{RB}^{U L} , {N}_{U L , B W P}^{s i z e} ) / P ]$$

bits, where P represents the RBG size configured by RRC signaling. For FDRA type 0 in 20 MHz BWP, RBG size can be configured to be 4 or 8 in some embodiments. Correspondingly, 2 or 3 RBGs are available for FDRA with RBG granularity. To improve resource efficiency, a smaller RBG size, e.g., 2 or 3 RBs, may be introduced for eRedcap UEs.

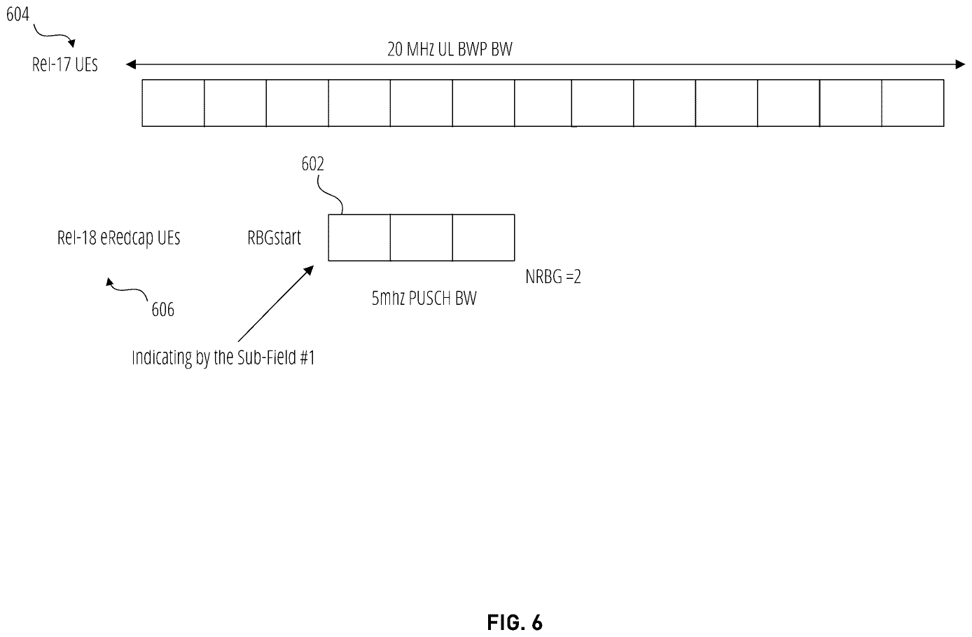

FIG. 6 illustrates one possible embodiment wherein both Type-0 and Type-1 RAs may be supported with the restriction of contiguous RB. In the illustrated embodiment, the RBG size (P) configured by RRC signaling is equal to 4 (i.e., P=4),

$${N}_{U L , B W P}^{s i z e}$$

is equal to 20 MHz, and there is a 30 kHz SCS. In the illustrated embodiment, the FDRA field May 13-bits if Rel-17 Type-0 RA is reused (e.g., Rel UEs 604) and is reduced to 6-bits (Sub-field 1 is 4-bit and Sub-field 2 is 2-bit) for embodiments using the new sub-field 1 and sub-field 2 (e.g., Rel-18 eRedCap UEs 606). Accordingly, there may be a 50% overhead reduction and eventually covers to improved coverage. As shown, the RBGₛₜₐᵣₜ is indicated by sub-field 1, and the Sub-field 2 may indicate a length (e.g., N_{RBG}=2).

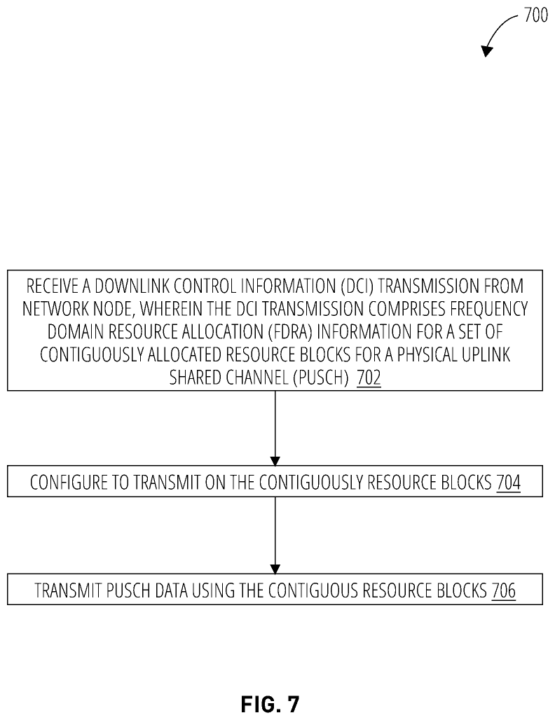

FIG. 7 illustrates a method 700 for a UE for frequency domain resource allocation. The UE may receive 702 a downlink control information (DCI) transmission from a network node. The DCI transmission may comprise FDRA information for a set of contiguously allocated resource blocks for a Physical Uplink Shared Channel (PUSCH).

For uplink resource allocation type-1, the FDRA information may comprise a value of a FDRA field that indicates a starting resource block (RB) and a length of the contiguously allocated resource blocks. The length of the contiguously allocated resource blocks may correspond to a minimum of: a size of an active bandwidth part, and a maximum number of resource blocks supported by the eRedCap UE. For uplink resource allocation type-2, the FDRA information may comprise: a first sub-filed indicating a starting resource block group index; and a second sub-field indicating a length field that indicates a number of RB Group (RBG) used for PUSCH transmission, the length field may be:

$${N}_{R B G} = [ {log}_{2} ( min ( {N}_{R B}^{U L} , {N}_{U L , B W P}^{s i z e} ) / P ] bits ,$$

where:
P represents a resource block group size configured by Radio Resource Control (RRC) signaling,

$${N}_{R B}^{U L}$$

is the maximum number of resource blocks supported by the eRedCap UE,

$${N}_{U L , B W P}^{s i z e}$$

is the size of the active bandwidth part.

The UE may configure 704 to transmit on the contiguously allocated resource blocks. The UE may transmit 706 PUSCH data using the contiguous resource blocks.

In some embodiments, the resource block group size configured by RRC signaling is two or three. In some embodiments, the method may include configuring non-contiguous resource blocks in an active downlink bandwidth part for a Physical Downlink Shared Channel (PDSCH). In some embodiments, a size of a maximum bandwidth for the active downlink bandwidth part for PDSCH is greater than a size of a maximum bandwidth for an active uplink bandwidth part for PUSCH. In some embodiments, a first maximum number of resource blocks allocated for the PDSCH is equal to a second maximum number of resource blocks allocated for the PUSCH. Some embodiments may further comprise receiving an indication from the network node that eRedCap devices are barred or not barred. In some embodiments, the indication may be provided by: repurposing a sparse bit in a master information block (MIB) payload; or re-interpreting one of two reserved bits in a Physical Broadcast Channel (PBCH) payload at least for FR1 licensed band; or repurposing one bit from the fifteen reserved bits in DCI Format 1_0 with cyclic redundancy check field (CRC) scrambled by System Information—Radio Network Temporary Identifier (SI-RNTI); or introducing a new information element (IE) in System Information Block 1 (SIB1). In some embodiments, the method may include determining a frequency offset value for PUCCH that is explicitly configured by SIB1 message. In some embodiments, the method may further comprise using an orthogonal code or orthogonal root sequence for PUCCH that is either explicitly configured by SIB1 message or hard-encoded in specification for eRedcap UEs. In some embodiments, the method may further comprise transmitting an indication that the eRedCap UE is an eRedCap device to the network node. In some embodiments, the eRedcap device is indicated by: a PRACH transmission on a separate initial uplink bandwidth part; or a PRACH resource configured by SIB1 within a shared initial uplink bandwidth part; or two dedicated Common Control Channel (CCCH) identifiers (IDs) that are used by the Message-3 (Msg3) in 4-step RACH procedure or MsgA PUSCH in 2-Step RACH procedure. In some embodiments, using CCCH IDs in Msg3 or MsgA PUSCH is enabled explicitly by SIB1 or always used by default for eRedcap devices, or using PRACH transmission to early identify a eRedcap device is explicitly enabled or disabled by SIB1 message.

Embodiments contemplated herein include an apparatus comprising means to perform one or more elements of the method 700. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of the method 700. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 1302 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

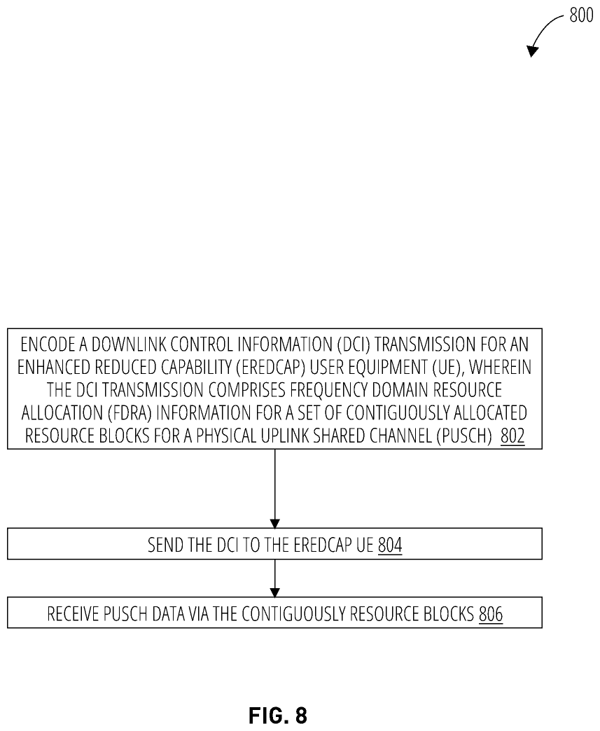

FIG. 8 illustrates a method 800 for a network node for frequency domain resource allocation. The network node may encode 802 a downlink control information (DCI) transmission for a eRedCap UE. The DCI transmission may comprise FDRA information for a set of contiguously allocated resource blocks for a Physical Uplink Shared Channel (PUSCH).

For uplink resource allocation type-1, the FDRA information may comprise a resource indication value field that indicates a length of the contiguously allocated resource blocks. The length of the contiguously allocated resource blocks may correspond to a minimum of: a size of an active bandwidth part, and a maximum number of resource blocks supported by the eRedCap UE. For uplink resource allocation type-2, the FDRA information may comprise: a first sub-filed indicating a starting resource block group index; and a second sub-field indicating a length field, the length field may be:

$${N}_{R B G} = [ {log}_{2} ( min ( {N}_{RB}^{UL} , {N}_{UL , BWP}^{s i z e} ) / P ] bits ,$$

where:
P represents a resource block group size configured by Radio Resource Control (RRC) signaling,

$${N}_{RB}^{UL}$$

is the maximum number of resource blocks supported by the eRedCap UE,

$${N}_{UL , BWP}^{size}$$

is the size of the active bandwidth part.

The network node may send 804 the DCI to the eRedCap UE, and receive 806 PUSCH data via the contiguous resource blocks.

In some embodiments, the resource block group size configured by RRC signaling is two or three. In some embodiments, the method may include configuring non-contiguous resource blocks in an active downlink bandwidth part for a Physical Downlink Shared Channel (PDSCH). In some embodiments, a size of a maximum bandwidth for an active downlink bandwidth part for PDSCH is greater than a size of a maximum bandwidth for an active uplink bandwidth part for PUSCH. In some embodiments, a first maximum number of allocated resource blocks for the PDSCH is equal to a second maximum number of resource blocks allocated for the PUSCH. In some embodiments, the method may include sending an indication to the eRedCap UE that eRedCap devices are barred or not barred. In some embodiments, the method may include determining a frequency offset value for PUCCH that is explicitly configured by SIB1 message. In some embodiments, the method may include using an orthogonal code or orthogonal root sequence for PUCCH that is either explicitly configured by SIB1 message or hard-encoded in specification for eRedcap UEs. In some embodiments, the method may include receiving an indication that the eRedCap UE is an eRedCap device.

Embodiments contemplated herein include an apparatus comprising means to perform one or more elements of the method 800. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 800. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a base station (such as a network device 1318 that is a base station, as described herein).

Embodiments contemplated herein include a signal as described in or related to one or more elements of the method 800.

Embodiments contemplated herein include a computer program or computer program product comprising instructions, wherein execution of the program by a processing element is to cause the processing element to carry out one or more elements of the method 800. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

One design goal when introducing Rel-18 eRedCap UEs is to ensure coexistence with non-RedCap UEs and Rel-17 RedCap UEs. Accordingly, some embodiments include mechanisms for PUCCH orthogonality between eRedcap-PUCCH without frequency hopping and legacy PUCCH with frequency hopping.

When a separate initial uplink BWP is configured for Rel-18 eRedcap UE, a variety of approaches may be considered for the configuration of PUCCH resource sets for Rel-18 eRedcap UEs (PUCCH_eRedcap) and PUCCH resource sets for non-eRedcap UEs (PUCCH_Non_eRedcap) in RRC_IDLE state (i.e., before a UE is provided with dedicated PUCCH resource set). Because non-eRedCap UEs may use frequency hopping and eRedCap UEs may not use frequency hopping, the following provides methods for reducing overlap between PUCCH resources.

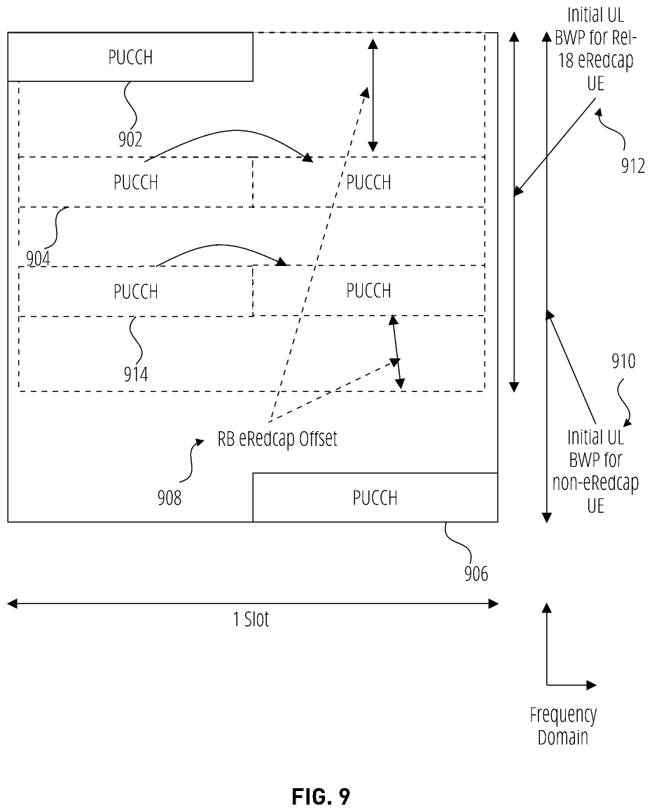

FIG. 9 illustrates an initial uplink BWP for Rel-18 eRedCap 912 and an initial uplink BWP for non-eRedCap 910. In some embodiments, the frequency hopping of common PUCCH resources for Rel-18 eRedcap can be enabled or disabled explicitly by SIB1 message. In the illustrated embodiment, frequency hopping is disabled, the eRedCap PUCCH resource set (PUCCH 904 and PUCCH 914) do not change frequency. In contrast, the non-eRedCap PUCCH resource set (PUCCH 902, and PUCCH 906) may use multiple frequencies using frequency hopping.

There are multiple benefits to disabling frequency hopping for eRedCap PUCCH. First, it enables the coexistence with Rel-17 Redcap UE with a shared PUCCH resource set by disabling frequency hopping. Second, it avoids the resource fragmentation and corresponding peak data rate reduction for the non-Redcap UE only supporting PUSCH with contiguous RA.

When frequency hopping for common PUCCH for Rel-18 eRedcap is deactivated, the network may provide a new parameter to indicate an additional Physical Resource Block (PRB) offset value

$$( R {B}_{offset}^{eRedcap} 908 )$$

### to the UK.

$$R {B}_{offset}^{eRedcap} 908$$

may be selected from a set of values hard-encoded in the 3GPP specification. The indicated value

$$R {B}_{offset}^{e R e d c a p} 908$$

may be on top of existing PRB offset value of legacy PUCCH resource for normal UE

$$( R {B}_{BWP}^{offset} ) .$$

In some designs, a default value ‘0’ may be assumed by eRedcap UE if this parameter is absent in SIB1.

In some embodiments, when frequency hopping for common PUCCH resource for eRedCap is disabled, the UE may determine the PRB index of the PUCCH transmission in one side of uplink BWP by using one of the following equations:

$$R {B}_{B W P}^{offset} + R {B}_{offset}^{eRedcap} + [ {r}_{pucch} / {N}_{C S} ]$$

$${N}_{B W P}^{e R e dcap , size} - 1 - R {B}_{B W P}^{offset} - R {B}_{offset}^{eRedcap} - [ {r}_{pucch} / {N}_{CS} ] ,$$

where

$${N}_{BWP}^{e R e dcap , size}$$

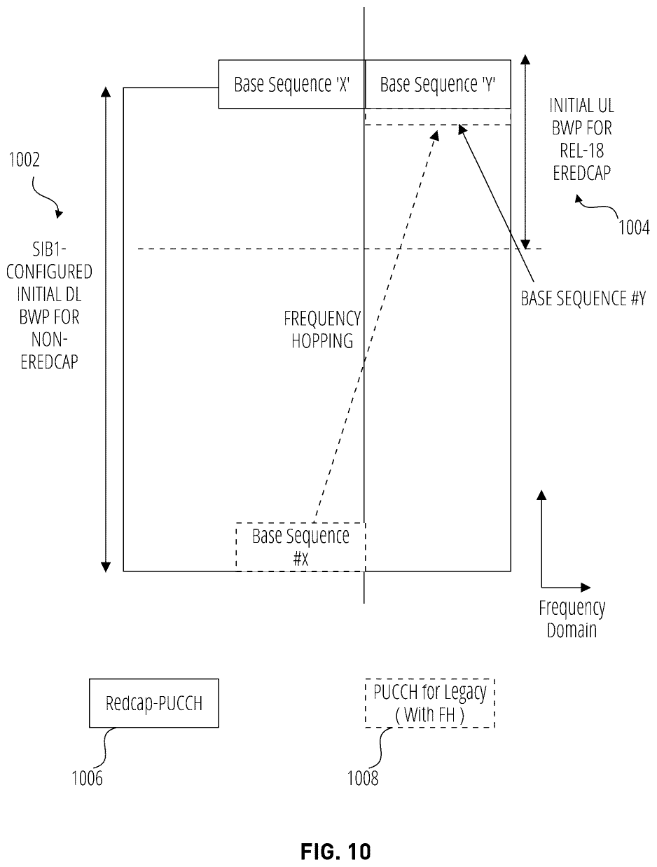

FIG. 10 illustrates partially overlapped resource blocks of PUCCH resources where the devices use different base sequences in accordance with some embodiments. Some embodiments may minimize the inter-UEs interference between the eRedCap PUCCH 1006 without frequency hopping and the non-RedCap PUCCH 1008 with frequency hopping within the initial uplink bandwidth part 1004.

In some embodiments, different base sequences ‘m’ may be used for different parts of PUCCH of eRedcap UEs even without frequency hopping being enabled. In some embodiments, there may be orthogonal root sequences for Rel-18 eRedcap UEs and other UEs with overlapped PUCCH resource. The symbol division of Redcap PUCCH may be determined based on the overlapping PUCCH resource that is used by non-Redcap UEs with FH.

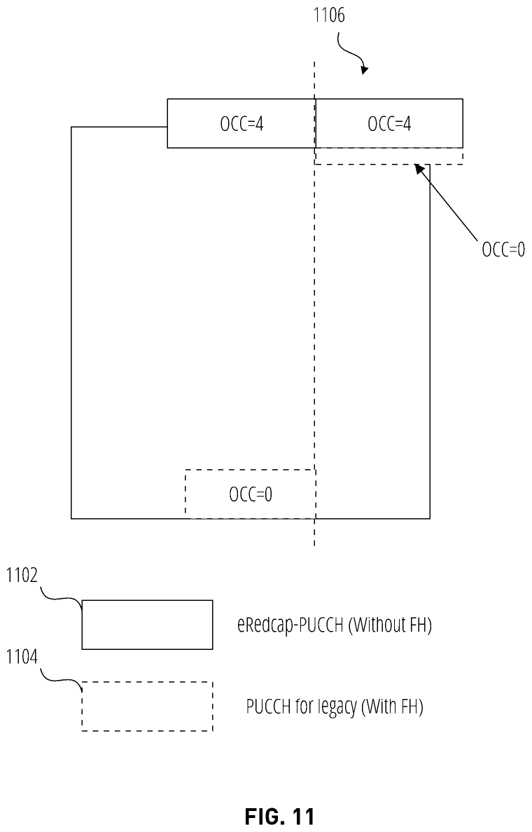

FIG. 11 illustrates partially overlapped resource blocks of PUCCH resources where the devices use an orthogonal code to limit interference in accordance with some embodiments. As shown, the eRedCap PUCCH 1006 may not use frequency hopping and the non-RedCap PUCCH 1008 may use frequency hopping within the initial uplink bandwidth part. This may lead to a time when PUCCH resources overlap (e.g., overlapping PUCCH resources 1106).

To limit interference, a new orthogonal code (OCC) with index X may be hard-encoded in specification or configured by SIB1, where X≠0. In some embodiments, X=[i/2] where i is the number of symbols of PUCCH-eRedcap. For example, in FIG. 11 i=8, where OCC #0 is used by non-Redcap UE and X=[i/2]=[8/2]=4 is used for eRedcap UE. This may result in orthogonality between the resources to reduce interference.

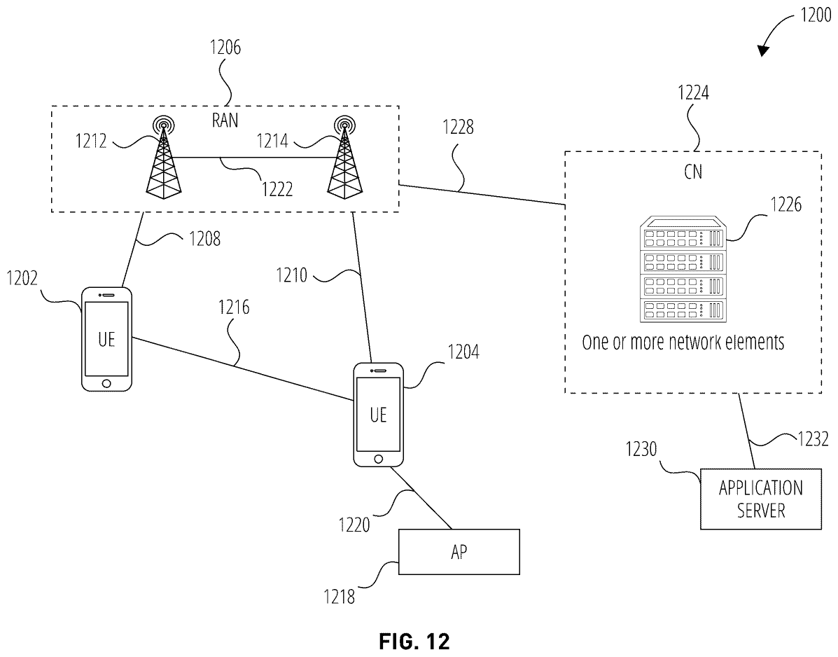

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

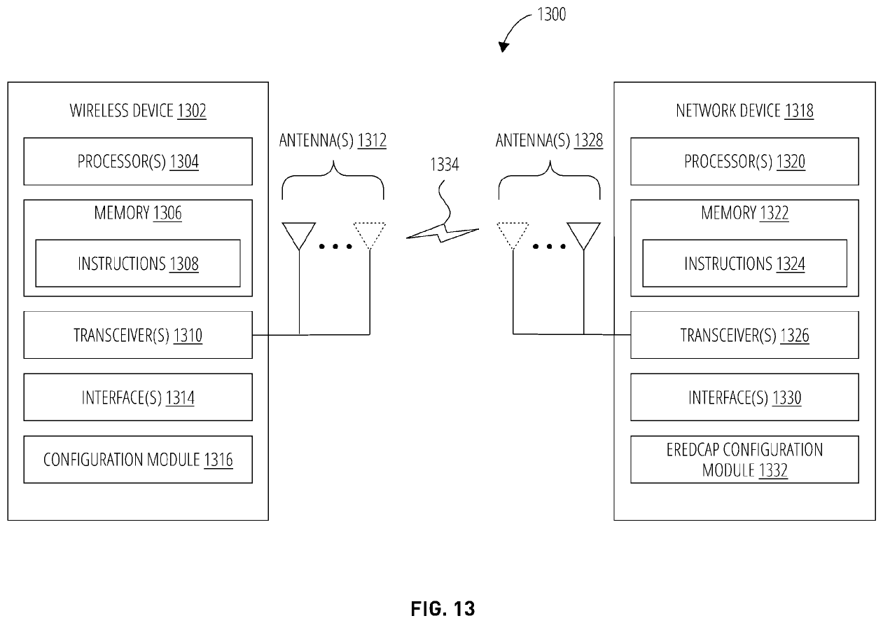

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include a configuration module 1316. The configuration module 1316 may be implemented via hardware, software, or combinations thereof. For example, the configuration module 1316 may be implemented as a processor, circuit, and/or instructions 1308 stored in the memory 1306 and executed by the processor(s) 1304. In some examples, the configuration module 1316 may be integrated within the processor(s) 1304 and/or the transceiver(s) 1310. For example, the configuration module 1316 may be implemented by a combination of software components (e.g., executed by a DSP or a general processor) and hardware components (e.g., logic gates and circuitry) within the processor(s) 1304 or the transceiver(s) 1310.

The configuration module 1316 may be used for various aspects of the present disclosure, for example, aspects of FIGS. 1-11. The configuration module 1316 is configured to send an indication that the wireless device 1302 is an eRedCap device, receive an indication indicating that the network device 1318 allows or bars eRedCap devices, and configure the wireless device 1302 for communication with the network device 1318.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include an eRedCap configuration module 1332. The eRedCap configuration module 1332 may be implemented via hardware, software, or combinations thereof. For example, the eRedCap configuration module 1332 may be implemented as a processor, circuit, and/or instructions 1324 stored in the memory 1322 and executed by the processor(s) 1320. In some examples, the eRedCap configuration module 1332 may be integrated within the processor(s) 1320 and/or the transceiver(s) 1326. For example, the eRedCap configuration module 1332 may be implemented by a combination of software components (e.g., executed by a DSP or a general processor) and hardware components (e.g., logic gates and circuitry) within the processor(s) 1320 or the transceiver(s) 1326.

The eRedCap configuration module 1332 may be used for various aspects of the present disclosure, for example, aspects of FIGS. 1-11. The eRedCap configuration module 1332 is configured to determine that a UE is an eRedCap device, configure an eRedCap device or inform the eRedCap device that it is barred.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an enhanced reduced capability (eRedCap) user equipment (UE), the method comprising:
receiving a downlink control information (DCI) transmission from a network node, wherein the DCI transmission comprises Frequency Domain Resource Allocation (FDRA) information for a allocated contiguous resource blocks for a Physical Uplink Shared Channel (PUSCH),
wherein for uplink resource allocation type-1, the FDRA information comprises a value of a FDRA field that indicates a starting resource block (RB) and a length of the allocated contiguous resource blocks, wherein the length of the allocated contiguous resource blocks corresponds to a minimum of:
a size of an active bandwidth part, and
a maximum number of resource blocks supported by the eRedCap UE;
configuring to transmit on the allocated contiguous resource blocks; and
transmitting PUSCH data using the allocated contiguous resource blocks.

2. The method of claim 1, wherein for uplink resource allocation type-0, the FDRA information comprises:
a first sub-filed indicating a starting resource block group index; and
a second sub-field indicating a length field that indicates a number of RB Group (RBG) used for PUSCH transmission, wherein the length field is:
$${N}_{RBG} = ( min ( {N}_{RB}^{UL} , {N}_{UL , BWP}^{s i z e} ) / P ] bits ,$$
where:
P represents a resource block group size configured by Radio Resource Control (RRC) signaling,
$${N}_{RB}^{UL}$$
is the maximum number of resource blocks supported by the eRedCap UE, and
$${N}_{UL , BWP}^{s i z e}$$
is the size of the active bandwidth part.

3. The method of claim 2, wherein the resource block group size configured by RRC signaling is two or three.

4. The method of claim 1, further comprising configuring non-contiguous resource blocks in an active downlink bandwidth part for a Physical Downlink Shared Channel (PDSCH).

5. The method of claim 4, wherein a size of a maximum bandwidth for the active downlink bandwidth part for PDSCH is greater than a size of a maximum bandwidth for an active uplink bandwidth part for PUSCH.

6. The method of claim 4, wherein a first maximum number of resource blocks allocated for the PDSCH is equal to a second maximum number of resource blocks allocated for the PUSCH.

7. The method of claim 1, further comprising receiving an indication from the network node that eRedCap devices are barred or not barred.

8. The method of claim 7, wherein the indication is provided by:
repurposing a sparse bit in a master information block (MIB) payload; or
re-interpreting one of two reserved bits in a Physical Broadcast Channel (PBCH) payload at least for FR1 licensed band; or
repurposing one bit from the fifteen reserved bits in DCI Format 1_0 with cyclic redundancy check field (CRC) scrambled by System Information-Radio Network Temporary Identifier (SI-RNTI); or
introducing a new information element (IE) in System Information Block 1 (SIB1).

9. The method of claim 1, further comprising determining a frequency offset value for PUCCH that is explicitly configured by SIB1 message.

10. The method of claim 1, further comprising using an orthogonal code or orthogonal root sequence for PUCCH that is either explicitly configured by SIB1 message or hard-encoded in specification for eRedcap UEs.

11. The method of claim 1, further comprising transmitting an indication that the eRedCap UE is an eRedCap device to the network node.

12. The method of claim 11, wherein the eRedcap device is indicated by:
a PRACH transmission on a separate initial uplink bandwidth part; or
a PRACH resource configured by SIB1 within a shared initial uplink bandwidth part; or
two dedicated Common Control Channel (CCCH) identifiers (IDs) that are used by the Message-3 (Msg3) in 4-step RACH procedure or MsgA PUSCH in 2-Step RACH procedure.

13. The method of claim 12, wherein:
using CCCH IDs in Msg3 or MsgA PUSCH is enabled explicitly by SIB1 or always used by default for eRedcap devices, or
using PRACH transmission to early identify a eRedcap device is explicitly enabled or disabled by SIB1 message.

14. A method for a network node, the method comprising:
encoding a downlink control information (DCI) transmission for an enhanced reduced capability (eRedCap) user equipment (UE), wherein the DCI transmission comprises Frequency Domain Resource Allocation (FDRA) information for allocated contiguous resource blocks for a Physical Uplink Shared Channel (PUSCH),
wherein for uplink resource allocation type-1, the FDRA information comprises a value of a FDRA field that indicates a starting resource block (RB) and a length of the allocated contiguous resource blocks, wherein the length of the allocated contiguous resource blocks corresponds to a minimum of:
a size of an active bandwidth part, and
a maximum number of resource blocks supported by the eRedCap UE;
sending the DCI to the eRedCap UE; and
receiving PUSCH data via the allocated contiguous resource blocks.

15. The method of claim 14, wherein for uplink resource allocation type-2, the FDRA information comprises:
a first sub-filed indicating a starting resource block group index; and
a second sub-field indicating a length field that indicates a number of RB Group (RBG) used for PUSCH transmission, wherein the length field is:
$${N}_{RBG} = ( min ( {N}_{RB}^{UL} , {N}_{UL , BWP}^{s i z e} ) / P ] bits ,$$
where:
P represents a resource block group size configured by Radio Resource Control (RRC) signaling,
$${N}_{RB}^{UL}$$
is the maximum number of resource blocks supported by the eRedCap UE, and
$${N}_{UL , BWP}^{s i z e}$$
is the size of the active bandwidth part.

16. The method of claim 15, wherein the resource block group size configured by RRC signaling is two or three.

17. The method of claim 14, further comprising configuring non-contiguous resource blocks in an active downlink bandwidth part for a Physical Downlink Shared Channel (PDSCH).

18. The method of claim 17, wherein a size of a maximum bandwidth for an active downlink bandwidth part for PDSCH is greater than a size of a maximum bandwidth for an active uplink bandwidth part for PUSCH.

19. The method of claim 17, wherein a first maximum number of allocated resource blocks for the PDSCH is equal to a second maximum number of resource blocks allocated for the PUSCH.

20. The method of claim 14, further comprising sending an indication to the eRedCap UE that eRedCap devices are barred or not barred.

21-26. (canceled)
